(19) United States
(12) Patent Application Publication
(10) Pub. No.: US 2020/0218876 A1
(43) Pub. Date: Jul. 9, 2020

(54) SCREEN PROTECTOR HAVING FINGERPRINT RECOGNIZABLE STRUCTURE ON DISPLAY INCLUDING ULTRASONIC FINGERPRINT RECOGNITION SENSOR AND MANUFACTURING METHOD THEREOF

(71) Applicant: Whitestone Co., Ltd., Cheonan-si (KR)

(72) Inventors: Chan-hyun Park, Suwon-si (KR); In-su Yoon, Cheonan-si (KR); Jae-yong Jeong, Cheonan-si (KR)

(21) Appl. No.: 16/538,060

(22) Filed: Aug. 12, 2019

(30) Foreign Application Priority Data
Jan. 7, 2019 (KR) 10-2019-0001562
Jan. 23, 2019 (KR) 10-2019-0008751
Apr. 19, 2019 (KR) 10-2019-0046278

(51) Int. Cl. G06K 9/00; B32B 7/12; B32B 15/20; B32B 15/08

(52) U.S. Cl. CPC G06K 9/00053; G06K 9/0002; B32B 7/12; B32B 2264/102; B32B 15/08; G06K 9/00087; B32B 15/20

(57) ABSTRACT

A screen protector having a fingerprint recognizable structure on a display including an ultrasonic fingerprint recognition sensor and a manufacturing method thereof. The screen protector having a fingerprint recognizable structure on a display including an ultrasonic fingerprint recognition sensor of the present invention includes: a liquid adhesive layer provided on a display of an electron device including an ultrasonic fingerprint recognition sensor; an anti-scattering film provided on the liquid adhesive layer to prevent scattering due to the damage to the display; a protector unit provided on the anti-scattering film; and a coating layer between the liquid adhesive layer and the anti-scattering film or between the anti-scattering film and the protector unit.

### BACKGROUND OF THE INVENTION

### Field of the Invention

The present invention relates to a screen protector and a manufacturing method thereof. More particularly, the invention relates to a screen protector having a fingerprint recognizable structure on a display including an ultrasonic fingerprint recognition sensor by minimizing a loss of an ultrasonic signal of a fingerprint recognition sensor while removing an air gap between a display and a screen protector of an electronic device to enhance an ultrasonic fingerprint recognition rate and a manufacturing method thereof.

### Description of the Related Art

A fingerprint sensor scans a fingerprint image and converts the scanned fingerprint image into an electrical signal. In order to capture the fingerprint image, an optical fingerprint sensor in the related art has an optical system for irradiating light to a fingerprint and reflecting the light. However, since an optical system—such as a prism, a reflection mirror, and a lens—generally has a considerable volume, it is difficult to miniaturize an electronic device which includes an optical fingerprint sensor.

On the other hand, the number and types of electronic devices including fingerprint sensors have been increased based on portable electronic devices such as mobile phones and tablets. In order to mount the fingerprint sensor on the front surface of the electronic device, a sensing unit of the fingerprint sensor contacting the fingerprint needs to be exposed to the outside.

Accordingly, in the case where a display of an electronic device is covered with a screen protector such as a cover glass or a transparent film in order to protect a design or a display panel, there is a disadvantage that the fingerprint recognition rate may be considerably lowered or the fingerprint may not be recognized.

Particularly, in the case of a ultrasonic fingerprint recognition sensor, an ultrasonic wave is used to scan the fine features of the skin surface layer, and when a conventional screen protector is attached to the display of the electronic device, there is a disadvantage that the fingerprint recognition rate is significantly lowered or the fingerprint is not recognized. Accordingly, improvement measures are required.

The above-described technical configuration is a background technique for assisting in the understanding of the present invention. This configuration is not intended to convey a conventional technology widely known in the art to which the present invention pertains.

### SUMMARY OF THE INVENTION

Therefore, the present invention has been made in an effort to provide a screen protector having a fingerprint recognition structure on a display including an ultrasonic fingerprint recognition sensor by minimizing a loss of an ultrasonic signal of a fingerprint recognition sensor while removing an air gap between a display and a screen protector of an electronic device to enhance an ultrasonic fingerprint recognition rate, and a manufacturing method thereof.

According to an aspect of the present invention, there is provided a screen protector including: a liquid adhesive layer provided on a display of an electron device including an ultrasonic fingerprint recognition sensor; an anti-scattering film provided on the liquid adhesive layer to prevent scattering due to the damage to the display; a protector unit provided on the anti-scattering film; and a coating layer between the liquid adhesive layer and the anti-scattering film or between the anti-scattering film and the protector unit.

At least one fingerprint recognition sensor hole may be provided in the anti-scattering film.

The coating layer may be formed of an organic or inorganic material.

The coating layer may be provided in multiple layers or a single layer.

The coating layer may be provided in a single layer, and the coating layer provided in the single layer may include at least one coating layer selected from an oxide film coating layer, a metal coating layer, and a conductive polymer coating layer.

The coating layer may be provided in multiple layers, and the coating layer provided in the multiple layers may include at least one coating layer selected from an oxide film coating layer, a metal coating layer, and a conductive polymer coating layer.

The coating layer may be provided in multiple layers, and the coating layer provided in the multiple layers may include a pair of oxide film coating layers, and a metal coating layer between the pair of oxide film coating layers.

A total thickness including the liquid adhesive layer, the anti-scattering film layer, the coating layer, and the protector unit may be provided in 0.2 mm to 0.5 mm.

The liquid adhesive layer may be provided as an adhesive containing a polymer having conductivity or permittivity.

The oxide film coating layer may be provided to include one selected among magnesium fluoride (MgF₂), silicon dioxide (SiO₂), alumina (Al₂O₃), and titanium dioxide (TiO₂).

The oxide film coating layer may be provided with a thickness of 1 to 12 nm.

In the oxide film coating layer, the alumina may be provided as a double layer between the anti-scattering film and the protector unit.

The metal coating layer may be provided to include one selected among aluminum (Al), germanium (Ge), nickel (Ni), tin (Sn), and tantalum (Ta).

The metal coating layer may be provided with a thickness of 1 to 12 nm.

The coating layer may be provided to include alumina and magnesium fluoride, and the coating layer may be provided between the anti-scattering film and the protector unit.

The coating layer may have a thickness of 9 to 11 nm.

The coating layer may be provided to include alumina and tantalum and the coating layer may be provided between the anti-scattering film and the protector unit.

The coating layer may have a thickness of 9 to 11 nm.

Further, according to another aspect of the present invention, there is provided a screen protector protecting a display of an electronic device including an ultrasonic fingerprint recognition sensor and attached to the display by a liquid adhesive layer, which includes a coating layer provided between the liquid adhesive layer and an anti-scattering film preventing scattering by damage to the display or between the anti-scattering film and the protector unit.

The coating layer may be provided to include one selected among magnesium fluoride (MgF₂), silicon dioxide (SiO₂), alumina (Al₂O₃), and titanium dioxide (TiO₂).

The coating layer may be provided to include one selected among aluminum (Al), germanium (Ge), nickel (Ni), tin (Sn), and tantalum (Ta).

The screen protector may further include at least one of a special coating layer provided on the liquid adhesive layer; and a plurality of oxide fine particles provided on the liquid adhesive layer.

Further, according to yet another aspect of the present invention, there is provided a method for manufacturing a screen protector protecting a display of an electronic device including an ultrasonic fingerprint recognition sensor and attached to the display by a liquid adhesive layer, which includes providing in a protector unit of the screen protector a coating layer reducing loss of an ultrasonic wave emitted from the ultrasonic fingerprint recognition sensor.

The method may further include at least one of providing a special coating layer on the liquid adhesive layer; and providing on the liquid adhesive layer a plurality of oxide fine particles.

According to the exemplary embodiments of the present invention, the screen protector is constituted by the liquid adhesive layer, the anti-scattering film, and the protector unit to remove an air gap between the display and the screen protector of the electronic device and the brightness of the fingerprint recognition sensor minimizes the loss of the ultrasonic signal to enhance the fingerprint recognition rate.

Further, the exemplary embodiment is coupled to the display of the electronic device regardless of the shape of the electronic device constituted by 2D, 2.5D or 3D by the liquid adhesive layer, thereby removing the air gap between the exemplary embodiment and the display of the electronic device.

Furthermore, the liquid adhesive layer is formed of a medium in which transmission of the ultrasonic signal is minimized after curing, thereby minimizing the loss of the signal.

In addition, in the exemplary embodiment, the coating layer minimizes the loss of the reflected ultrasonic wave, thereby obtaining a clear image of the fingerprint.

Further, in the exemplary embodiment, a distance between the fingerprint recognition sensor and a user's fingerprint is minimized, thereby improving the fingerprint recognition efficiency.

Furthermore, in the exemplary embodiment, a special coating layer or a plurality of oxide fine particles having a higher hardness than the liquid adhesive layer is provided in the area of the liquid adhesive layer which is an upper area of the fingerprint recognition sensor, thereby increasing a recognition speed of the fingerprint recognition sensor.

### BRIEF DESCRIPTION OF THE DRAWINGS

FIG. 1 is a diagram schematically illustrating that a screen protector having a fingerprint recognizable structure on a display including an ultrasonic fingerprint sensor is provided in an electronic device according to an exemplary embodiment of the present invention.

FIG. 2 is a schematic exploded view of FIG. 1.

FIG. 3 is a diagram schematically illustrating that a fingerprint recognition sensor hole is provided in an anti-scattering film illustrated in FIG. 2.

FIG. 4 is a diagram schematically illustrating that a coating layer illustrated in FIG. 1 is provided between a liquid adhesive layer and the anti-scattering film.

FIG. 5 illustrates another exemplary embodiment of the coating layer illustrated in FIG. 1.

FIG. 6 illustrates another exemplary embodiment of the coating layer illustrated in FIG. 4.

FIG. 7 is a plan view schematically illustrating a position where a special coating layer is provided in the exemplary embodiment.

FIG. 8 is a cross-sectional view schematically illustrating a lamination position of the special coating layer illustrated in FIG. 7.

### DETAILED DESCRIPTION OF THE PREFERRED EMBODIMENT

In order to sufficiently appreciate the present invention, operational advantages of the present invention, objects achieved by exemplary embodiments the present invention, accompanying drawings illustrating the exemplary embodiments of the present invention and contents disclosed in the accompanying drawings should be referred.

Hereinafter, by describing a preferred exemplary embodiment of the present invention with reference to the accompanying drawings, the present invention will be described in detail. Like reference numerals illustrated in the respective drawings designate like members.

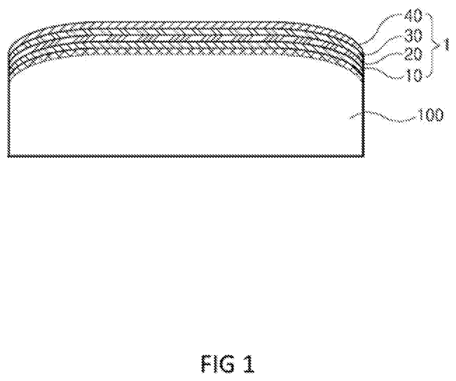

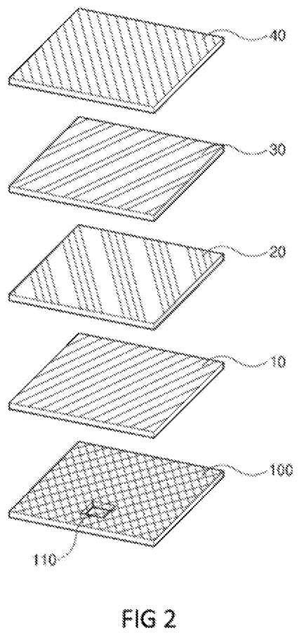

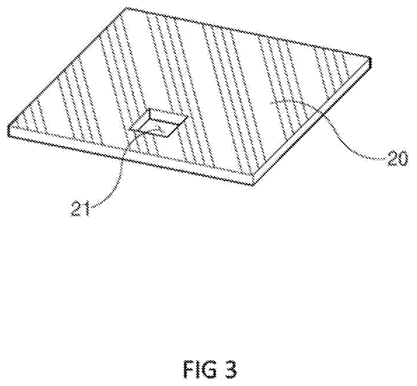

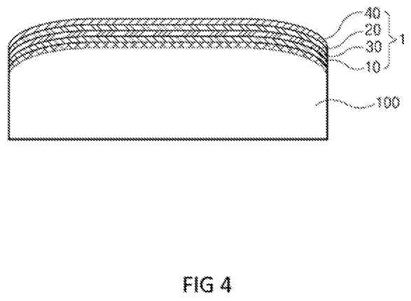

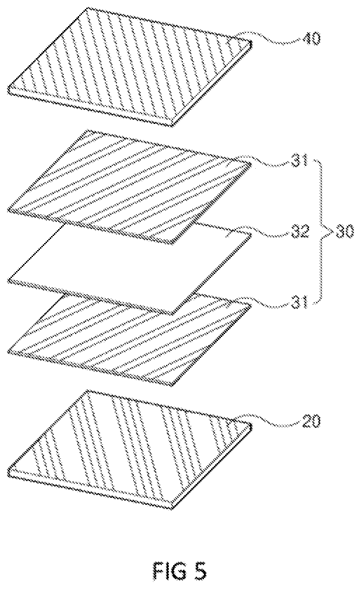

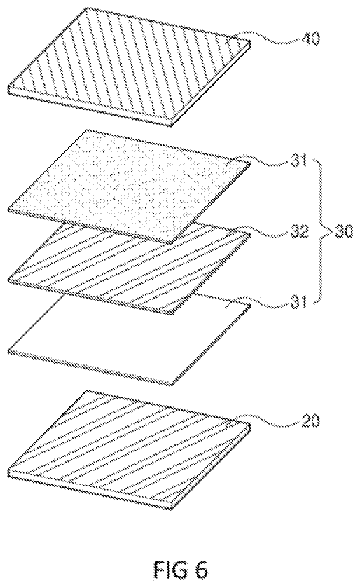

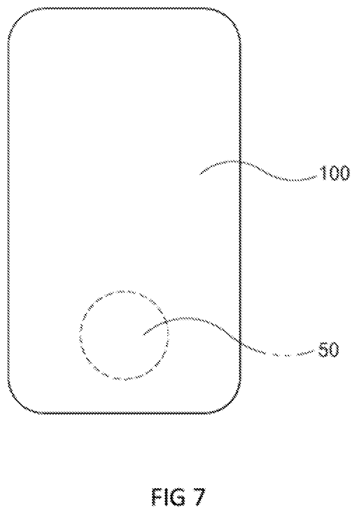

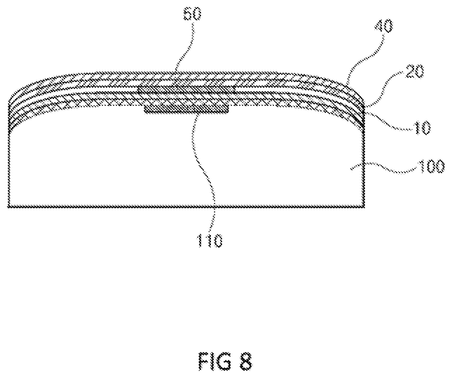

FIG. 1 is a diagram schematically illustrating that a screen protector having a fingerprint recognizable structure on a display including an ultrasonic fingerprint sensor is provided in an electronic device according to an exemplary embodiment of the present invention, FIG. 2 is a schematic exploded view of FIG. 1, FIG. 3 is a diagram schematically illustrating that a fingerprint recognition sensor hole is provided in an anti-scattering film illustrated in FIG. 2, FIG. 4 is a diagram schematically illustrating that a coating layer illustrated in FIG. 1 is provided between a liquid adhesive layer and the anti-scattering film, FIG. 5 illustrates another exemplary embodiment of the coating layer illustrated in FIG. 1, FIG. 6 illustrates another exemplary embodiment of the coating layer illustrated in FIG. 4, FIG. 7 is a plan view schematically illustrating a position where a special coating layer is provided in the exemplary embodiment, and FIG. 8 is a cross-sectional view schematically illustrating a lamination position of the special coating layer illustrated in FIG. 7.

As illustrated in the drawings, a screen protector 1 having a fingerprint recognizable structure on a display including an ultrasonic fingerprint recognition sensor according to the present embodiment includes a liquid adhesive layer 10 provided on the display of an electronic device 100 including an ultrasonic fingerprint recognition sensor 110, an anti-scattering film 20 provided on the liquid adhesive layer 10 to prevent scattering due to the damage to the display, a coating layer 30 provided above the anti-scattering film 20, a protector unit 40 above the coating layer 30, and a special coating layer 50 provided on the liquid adhesive layer 10.

As illustrated in FIG. 1, the liquid adhesive layer 10 may be attached to the display of the electronic device 100 to couple the exemplary embodiment to the display of the electronic device 100.

In the present embodiment, the liquid adhesive layer 10 is coupled to the display of the electronic device 100 regardless of the shape of the electronic device 100 constituted by 2D, 2.5D, or 3D to remove an air gap between the present embodiment and the display of the electronic device 100, and the liquid adhesive layer 10 is formed of a medium in which transmission of an optical or ultrasonic signal is minimized after curing to minimize a loss of the signal.

Furthermore, in the present embodiment, the liquid adhesive layer 10 may be formed by applying an adhesive composition having fluidity to the display of the electronic device 100, loading the protector unit 40 onto the display of the electronic device 100 to spread the adhesive composition over the entire area of the lower surface of the protector unit 40 by the weight of the protector unit 40, and then curing the adhesive composition.

In addition, in the present embodiment, the adhesive composition may be cured by photopolymerization or thermal polymerization and may include an ultraviolet (UV) polymerizable oligomer and a photopolymerization initiator.

Further, in the present embodiment, the adhesive composition may further include a diluent, which may adjust the viscosity of the adhesive composition and improve the physical properties of the liquid adhesive layer 10 after curing.

Further, in the present embodiment, the adhesive composition may further include additives such as a photosensitizer, a colorant, a thickener, a polymerization inhibitor and the like.

Meanwhile, in the present embodiment, the adhesive composition may be provided as a medium in which the transmission of the ultrasound signal is minimized after the liquid adhesive layer 10 is cured. To this end, in the present embodiment, the adhesive composition may be formed of an acrylic adhesive composition.

In the present embodiment, the liquid adhesive layer 10 may be provided as an adhesive containing a polymer having high conductivity or high permittivity.

As illustrated in FIGS. 1 and 2, the anti-scattering film 20 is provided on the liquid adhesive layer 10 to prevent the damaged pieces of the display from being scattered when the display of the electronic device 100 is damaged.

In the present embodiment, as illustrated in FIG. 3, a fingerprint recognition sensor hole 21 is provided in the anti-scattering film 20 to improve the fingerprint recognition efficiency of the ultrasonic fingerprint recognition sensor 110.

In the present embodiment, the fingerprint recognition sensor hole 21 may be provided vertically above the ultrasonic fingerprint recognition sensor 110 and may be provided in one or more of the sensors.

As illustrated in FIG. 1, the coating layer 30 is provided on the anti-scattering film 20 and may serve to minimize the loss of the reflected signal of the ultrasonic waves emitted from the ultrasonic fingerprint recognition sensor 110 to obtain a clear image of the fingerprint.

In the present embodiment, the coating layer 30 may be formed by synthesizing organic or inorganic materials.

Further, in the present embodiment, the coating layer 30 may be provided in a single layer as illustrated in FIG. 1 or may be provided in multiple layers as illustrated in FIG. 5.

In the present embodiment, when the coating layer 30 is provided in a single layer, the coating layer 30 may include one coating layer selected from an oxide film coating layer 31, a metal coating layer 32, and a conductive polymer coating layer.

Further, in the present embodiment, when the coating layer 30 is provided in multiple layers, as illustrated in FIG. 5, the coating layer 30 may include a pair of oxide film coating layers 31, and a metal coating layer 32 provided between the pair of oxide film coating layers 31.

Meanwhile, in the present embodiment, the coating layer 30 may be provided in a single layer between the liquid adhesive layer 10 and the anti-scattering film 20 as illustrated in FIG. 4 or may be provided in multiple layers as illustrated in FIG. 6.

In the present embodiment, when the coating layer 30 is provided in a single layer, the coating layer 30 may include one coating layer selected from the oxide film coating layer 31, the metal coating layer 32, and a conductive polymer coating layer.

Further, in the present embodiment, when the coating layer 30 is provided in multiple layers, as illustrated in FIG. 6, the coating layer 30 may include a pair of oxide film coating layers 31, and a metal coating layer 32 provided between the pair of oxide film coating layers 31.

Specifically, in the present embodiment, the oxide coating layer 31 of the coating layer 30 may be formed of one selected from magnesium fluoride (MgF₂), silicon dioxide (SiO₂), alumina (Al₂O₃), and titanium dioxide (TiO₂), and the oxide coating layer 31 may have a thickness of 1 to 12 nm. In the present embodiment, the oxide coating layer 31 may be a double layer of alumina. In this case, the oxide coating layer 31 may be provided between the anti-scattering film 20 and the protector unit 40. Further, in the present embodiment, the oxide coating layer 31 may be formed of a composite oxide film of alumina and titanium.

In the exemplary embodiment, after the oxide film coating layer 31 is provided with the thickness described above, touch and fingerprint recognition is tested by providing a thickness of the protector unit 40 as 0.23 nm, a thickness of the anti-scattering film 20 as 30 μm, and a thickness of the liquid adhesive layer 10 as 30 μm, and as a result, recognition and release of the fingerprint are smoothly achieved.

Further, in the exemplary embodiment, as a result of performing the fingerprint recognition test while maintaining the thickness of the liquid adhesive layer 10 to 100 m, the thickness of the oxide film coating layer 31 to a predetermined thickness, for example, the thickness of the oxide film coating layer 31 made of magnesium fluoride to 10 nm, the thickness of the oxide film coating layer 31 made of silicon dioxide to 2 nm, the thickness of the double oxide film coating layer 31 made of alumina to 10 nm, and the thickness of the oxide film coating layer 31 made of titanium dioxide to 2 nm, the fingerprint is recognized up to a maximum of 0.26 nm in the protector unit 40.

Furthermore, in the exemplary embodiment, as a result of performing the fingerprint recognition test while maintaining the thickness of the liquid adhesive layer 10 to 100 m, the thickness of the oxide film coating layer 31 to a predetermined thickness, for example, the thickness of the oxide film coating layer 31 made of magnesium fluoride to 10 nm, the thickness of the oxide film coating layer 31 made of silicon dioxide to 2 nm, the thickness of the double oxide film coating layer 31 made of alumina to 10 nm, the thickness of the oxide film coating layer 31 made of titanium dioxide to 2 nm, and the thickness of the protector unit 40 to 0.23 nm, the fingerprint is recognized up to a maximum of 0.55 μm in the anti-scattering film 20.

In addition, in the exemplary embodiment, as a result of performing the fingerprint recognition test while maintaining the thickness of the protector unit 40 to 0.23 nm, the thickness of the anti-scattering film 20 to 30 μm, the thickness of the liquid adhesive layer 10 to 100 μm, the thickness of the oxide film coating layer 31 to a predetermined thickness, for example, the thickness of the oxide film coating layer 31 made of magnesium fluoride to 10 nm, the thickness of the oxide film coating layer 31 made of silicon dioxide to 2 nm, the thickness of the double oxide film coating layer 31 made of alumina to 10 nm, and the thickness of the oxide film coating layer 31 made of titanium dioxide to 2 nm, the fingerprint is recognized up to a maximum of 120 μm in the case of the thickness of the liquid adhesive layer 10.

Meanwhile, in the exemplary embodiment, the metal coating layer 32 of the coating layer 30 may be provided to includes one selected among aluminum (Al), germanium (Ge), liquid metal, nickel (Ni), tin (Sn), and tantalum and the metal coating layer 320 may be provided with a thickness of 1 to 12 nm.

In the exemplary embodiment, as a result of testing whether the touch and fingerprint are recognized by setting the thickness of the protector unit 40 to 0.23 nm, the thickness of the anti-scattering film 20 to 30 μm, the thickness of the liquid adhesive layer to 30 μm after the metal coating layer 320 is provided with the aforementioned configuration and thickness, the fingerprint is smoothly registered and cancelled.

Further, in the exemplary embodiment, as a result of performing the fingerprint recognition test while maintaining the thickness of the liquid adhesive layer 10 to 100 μm, the thickness of the metal coating layer 32 to a predetermined thickness, for example, the thickness of the metal coating layer 320 made of germanium to 10 nm, the thickness of the metal coating layer 320 made of liquid metal to 2 nm, the thickness of the metal coating layer 320 made of nickel to 2 nm, the thickness of the metal coating layer 320 made of tin to 2 nm, and the thickness of the metal coating layer 320 made of tantalum to 10 nm, the fingerprint is recognized up to a maximum of 0.26 nm in the protector unit 40.

Furthermore, in the exemplary embodiment, as a result of performing the fingerprint recognition test while maintaining the thickness of the liquid adhesive layer 10 to 100 μm, the thickness of the metal coating layer 32 to a predetermined thickness, for example, the thickness of the metal coating layer 320 made of germanium to 10 nm, the thickness of the metal coating layer 320 made of liquid metal to 2 nm, the thickness of the metal coating layer 320 made of nickel to 2 nm, the thickness of the metal coating layer 320 made of tin to 2 nm, the thickness of the metal coating layer 320 made of tantalum to 10 nm, and the thickness of the protector unit 40 to 0.23 nm, the fingerprint is recognized up to a maximum of 0.23 nm in the anti-scattering film 20.

In addition, in the exemplary embodiment, as a result of performing the fingerprint recognition test while maintaining the thickness of the protector unit 40 to 0.23 nm, the thickness of the anti-scattering film 20 to 30 μm, the thickness of the metal coating layer 32 to a predetermined thickness, for example, the thickness of the metal coating layer 320 made of germanium to 10 nm, the thickness of the metal coating layer 320 made of liquid metal to 2 nm, the thickness of the metal coating layer 320 made of nickel to 2 nm, the thickness of the metal coating layer 320 made of tin to 2 nm, and the thickness of the metal coating layer 320 made of tantalum to 10 nm, the fingerprint is recognized up to a maximum of 120 μm in the case of the thickness of the liquid adhesive layer 10.

In addition, in the exemplary embodiment, the coating layer 30 is provided as a mixed coating layer containing alumina and magnesium fluoride, and the mixed coating layer may be provided between the anti-scattering film 20 and the protector unit 40 and may have a thickness of 9 to 11 nm. In this case, there is an advantage that a superior fingerprint recognition rate is obtained under the conditions of the test described above.

Further, in the exemplary embodiment, the coating layer 30 is provided as a mixed coating layer containing alumina and magnesium fluoride, and the mixed coating layer may be provided between the anti-scattering film 20 and the protector unit 40 and may have a thickness of 9 to 11 nm. In this case, there is an advantage that a superior fingerprint recognition rate is obtained under the conditions of the test described above.

Furthermore, in the exemplary embodiment, the coating layer 30 is provided as a mixed coating layer containing alumina and tantalum, and the mixed coating layer may be provided between the anti-scattering film 20 and the protector unit 40 and may have a thickness of 1 to 3 nm. In this case, there is an advantage that a superior fingerprint recognition rate is obtained under the conditions of the test described above.

The protector unit 40 serves to prevent the display unit of the electronic device 100 from being damaged, and in the present embodiment, the protector unit 40 may be made of glass or a synthetic polymer material.

As illustrated in FIG. 8, the special coating layer 50 is provided on the liquid adhesive layer 10 so as to be disposed on the upper part of the fingerprint recognition sensor 110 and provided to have a hardness higher than that of the liquid adhesive layer 10, thereby increasing the recognition speed of the fingerprint recognition sensor 110.

In the present embodiment, the special coating layer 50 may be provided in the form of high hardness, high density and polymer film.

In the present embodiment, a plurality of fine oxide particles are added to the inside of the liquid adhesive layer 10 so that a region to which the plurality of fine oxide particles are added has a higher hardness than that of the other region of the liquid adhesive layer 10, thereby increasing the recognition speed of the fingerprint recognition sensor 110.

In the present embodiment, the plurality of fine oxide particles may include tungsten carbide.

Meanwhile, in the present embodiment, the ultrasonic fingerprint recognition sensor 110 may be provided on the display of the electronic device 100 or may be provided on a main body of the electronic device 100.

As described above, in the present embodiment, the screen protector is constituted by the liquid adhesive layer, the anti-scattering film, and the protector unit to remove an air gap between the display and the screen protector of the electronic device and the brightness of the fingerprint recognition sensor is transmitted without the loss of the ultrasonic signal to improve the fingerprint recognition rate.

Further, the present embodiment is coupled to the display of the electronic device regardless of the shape of the electronic device constituted by 2D, 2.5D or 3D by the liquid adhesive layer, thereby removing the air gap between the present embodiment and the display of the electronic device.

Furthermore, the liquid adhesive layer is formed of a medium in which transmission of the ultrasonic signal is minimized after curing, thereby minimizing the loss of the signal.

In addition, in the present embodiment, the coating layer minimizes the loss of the reflected ultrasonic wave, thereby obtaining a clear image of the fingerprint.

Further, in the present embodiment, a distance between the fingerprint recognition sensor and a user's fingerprint is minimized, thereby improving the fingerprint recognition efficiency.

As described above, the present invention is not limited to the exemplary embodiments described herein, and it would be apparent to those skilled in the art that various changes and modifications might be made without departing from the spirit and the scope of the present invention. Therefore, it will be determined that the changed examples or modified examples are included in the appended claims of the present invention.

1. A screen protector comprising:
a liquid adhesive layer provided on a display of an electronic device including an ultrasonic fingerprint recognition sensor;
an anti-scattering film provided on the liquid adhesive layer to prevent scattering due to damage to the display;
a protector unit provided on the anti-scattering film; and
a coating layer between one of either the liquid adhesive layer and the anti-scattering film or the anti-scattering film and the protector unit.

2. The screen protector of claim 1, wherein at least one fingerprint recognition sensor hole is provided in the anti-scattering film.

3. The screen protector of claim 1, wherein the coating layer is provided in a single layer, and the coating layer provided in the single layer includes at least one coating layer selected from an oxide film coating layer, a metal coating layer, and a conductive polymer coating layer.

4. The screen protector of claim 1, wherein the coating layer is provided in multiple layers, and the coating layer provided in multiple layers includes one coating layer selected from an oxide film coating layer, a metal coating layer, and a conductive polymer coating layer.

5. The screen protector of claim 1, wherein the coating layer is provided in multiple layers, and the coating layer provided in the multiple layers includes a pair of oxide film coating layers, and a metal coating layer between the pair of oxide film coating layers.

6. The screen protector of claim 1, wherein a total thickness including the liquid adhesive layer, the anti-scattering film layer, the coating layer, and the protector unit is provided in 0.2 to 0.5 mm.

7. The screen protector of claim 1, wherein the liquid adhesive layer is provided as an adhesive containing a polymer having conductivity or permittivity.

8. The screen protector of claim 3, wherein the oxide film coating layer is provided to include one selected among magnesium fluoride (MgF₂), silicon dioxide (SiO₂), alumina (Al₂O₃), and titanium dioxide (TiO₂).

9. The screen protector of claim 8, wherein the oxide film coating layer is provided with a thickness of 1 to 12 nm.

10. The screen protector of claim 8, wherein in the oxide film coating layer, the alumina is provided as a double layer between the anti-scattering film and the protector unit.

11. The screen protector of claim 3, wherein the metal coating layer is provided to include one selected among aluminum (Al), germanium (Ge), nickel (Ni), tin (Sn), and tantalum (Ta).

12. The screen protector of claim 4, wherein the metal coating layer is provided to include one selected among aluminum (Al), germanium (Ge), nickel (Ni), tin (Sn), and tantalum (Ta).

13. The screen protector of claim 11, wherein the metal coating layer is provided with a thickness of 1 to 12 nm.

14. The screen protector of claim 12, wherein the metal coating layer is provided with a thickness of 1 to 12 nm.

15. The screen protector of claim 1, wherein the coating layer is provided to include alumina and magnesium fluoride, and the coating layer is provided between the anti-scattering film and the protector unit.

16. The screen protector of claim 15, wherein the coating layer has a thickness of 9 to 11 nm.

17. The screen protector of claim 1, wherein the coating layer is provided to include alumina and tantalum, and the coating layer is provided between the anti-scattering film and the protector unit.

18. The screen protector of claim 17, wherein the coating layer has a thickness of 9 to 11 nm.

19. A screen protector protecting a display of an electronic device including an ultrasonic fingerprint recognition sensor and attached to the display by a liquid adhesive layer, comprising:
a coating layer provided between the liquid adhesive layer and an anti-scattering film preventing scattering by damage to the display or between the anti-scattering film and the protector unit.

20. The screen protector of claim 19, wherein the coating layer is provided to include one selected among magnesium fluoride (MgF₂), silicon dioxide (SiO₂), alumina (Al₂O₃), and titanium dioxide (TiO₂).

21. The screen protector of claim 19, wherein the coating layer is provided to include one selected among aluminum (Al), germanium (Ge), nickel (Ni), tin (Sn), and tantalum (Ta).

22. The screen protector of claim 1, further comprising:
at least one of a special coating layer provided on the liquid adhesive layer; and
a plurality of oxide fine particles provided on the liquid adhesive layer.

23. A method for manufacturing a screen protector protecting a display of an electronic device including an ultrasonic fingerprint recognition sensor and attached to the display by a liquid adhesive layer, comprising the step of:
providing in a protector unit of the screen protector a coating layer reducing loss of an ultrasonic wave emitted from the ultrasonic fingerprint recognition sensor.

24. The method of claim 23, further comprising the step of at least one of:
providing a special coating layer on the liquid adhesive layer; and
providing on the liquid adhesive layer a plurality of oxide fine particles.

25. The screen protector of claim 4, wherein the oxide film coating layer is provided to include one selected among magnesium fluoride (MgF₂), silicon dioxide (SiO₂), alumina (Al₂O₃), and titanium dioxide (TiO₂).

26. The screen protector of claim 25, wherein the oxide film coating layer is provided with a thickness of 1 to 12 nm.

27. The screen protector of claim 25, wherein in the oxide film coating layer, the alumina is provided as a double layer between the anti-scattering film and the protector unit.
